(19) United States
(12) Patent Application Publication
(10) Pub. No.: US 2015/0279067 A1
(43) Pub. Date: Oct. 1, 2015

(54) COMMAND CONTROLLER, METHOD FOR CONTROLLING COMMAND, AND INTEGRATED CIRCUIT

(71) Applicant: Panasonic Intellectual Property Management Co., Ltd., Osaka (JP)

(72) Inventor: Masato YUDA, Osaka (JP)

(21) Appl. No.: 14/667,325

(22) Filed: Mar. 24, 2015

(30) Foreign Application Priority Data
Mar. 25, 2014 (JP) 2014-061328
Feb. 10, 2015 (JP) 2015-024708

(51) Int. Cl. G06T 11/20

(52) U.S. Cl. CPC G06T 11/20

(57) ABSTRACT

A command controller for executing commands to draw images in a plurality of drawing-areas on a screen includes: a first storage storing a first command to draw an image in a first drawing-area having a first drawing-priority, among the drawing-areas; a second storage storing a second command to draw an image in a second drawing-area having a second drawing-priority lower than the first drawing-priority, among the drawing-areas; and a command execution unit executing, every predetermined period, the first command stored in the first storage to draw the image in the first drawing-area. The execution unit determines whether the first command is completely executed within a threshold-time shorter than the predetermined period from starting of the predetermined period. When the first command is determined to be completely executed within the threshold-time, the execution unit executes the second command stored in the second storage to draw the image in the second drawing-area.

### BACKGROUND

1. Field

The present disclosure relates to command controllers, methods for controlling commands, and integrated circuits for use therein.

2. Description of the Related Art

Japanese patent unexamined publication No. 2010-182139 discloses a drawing control device capable of shortening the duration from a point in time when higher priority processing occurs to a point in time when execution of the processing is started, even in the case where its hardware does not support interrupts and the like.

### SUMMARY

A command controller according to the present disclosure is intended to execute commands to draw images in a plurality of drawing areas on a screen. The command controller includes a first storage unit, a second storage unit, and a command execution unit. The first storage unit stores a first command to draw an image in a first drawing area having a first drawing priority, among the plurality of the drawing areas. The second storage unit stores a second command to draw an image in a second drawing area having a second drawing priority lower than the first drawing priority, among the plurality of the drawing areas. The command execution unit executes, every predetermined period, the first command stored in the first storage unit to draw the image in the first drawing area. Moreover, the command execution unit determines whether or not execution of the first command is completed at time within a threshold time shorter than the predetermined period from the starting point of the predetermined period. When the execution of the first command is determined to be completed at time within the threshold time, the command execution unit executes the second command stored in the second storage unit to draw the image in the second drawing area.

### BRIEF DESCRIPTION OF DRAWINGS

FIG. 1 is a block diagram of a configuration of a command controller according to an embodiment;

FIG. 2A is a first illustrative view of processing of the command controller according to the embodiment;

FIG. 2B is a second illustrative view of the processing of the command controller according to the embodiment;

FIG. 3 is a flowchart which illustrates command execution processing of the command controller according to the embodiment;

FIG. 4 is a flowchart which illustrates a suspension-resumption process executed by the command controller according to the embodiment;

FIG. 5 is an illustrative view of a series of processes executed by the command controller according to the embodiment; and

FIG. 6 is a block diagram of another configuration of the command controller according to the embodiment.

### DETAILED DESCRIPTION

Hereinafter, descriptions will be made regarding an embodiment, with reference to the accompanying drawings as deemed appropriate. It is noted, however, that descriptions in more detail than necessary will sometimes be omitted. For example, detailed descriptions of well-known items and duplicate descriptions of substantially the same configuration will sometimes be omitted, for the sake of brevity of the following descriptions and easy understanding by those skilled in the art.

Note that the inventors provide the accompanying drawings and the following descriptions so as to facilitate fully understanding of the present disclosure by those skilled in the art, and have no intention of imposing any limitation on the subject matter set forth in the appended claims.

### Exemplary Embodiment

### 1-1. Configuration

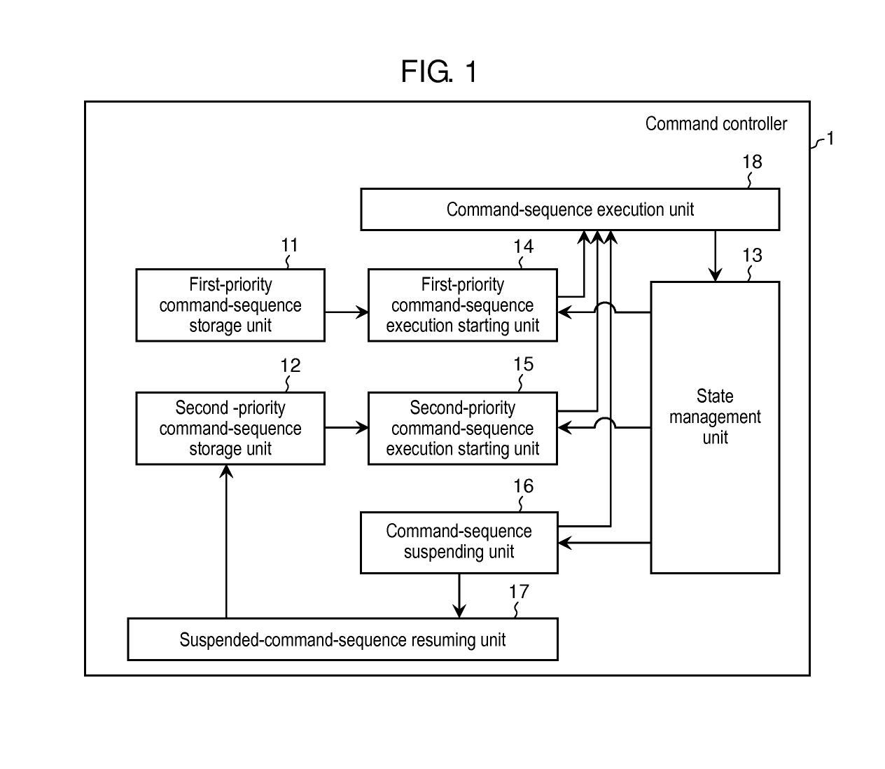

FIG. 1 is a block diagram of a configuration of a command controller according to the embodiment.

As shown in FIG. 1, command controller 1 includes first-priority command-sequence storage unit 11, second-priority command-sequence storage unit 12, state management unit 13, first-priority command-sequence execution starting unit 14, second-priority command-sequence execution starting unit 15, command-sequence suspending unit 16, suspended-command-sequence resuming unit 17, and command-sequence execution unit 18.

Command controller 1 controls the execution of a command sequence (also referred to simply as a command, hereinafter) to draw an image in a drawing area, based on drawing priority which is set for every one of a plurality of drawing areas on a screen.

In first-priority command-sequence storage unit 11, a command sequence (also referred to as a “first-priority command sequence” or “first command,” hereinafter) is set to draw an image in the drawing area having the highest drawing priority among the plurality of the drawing areas on the screen. The priority of the first-priority command sequence is also referred to as the first drawing priority. That is, first-priority command-sequence storage unit 11 is a register or a storage area which stores the first command to draw the image in the first drawing area having the first drawing priority among the plurality of the drawing areas. First-priority command-sequence storage unit 11 corresponds to a first storage unit.

More specifically, in first-priority command-sequence storage unit 11, a start and end addresses of memory (not shown) which stores the command sequence are set. First-priority command-sequence storage unit 11 transmits the first-priority command sequence to first-priority command-sequence execution starting unit 14, in response to a request from first-priority command-sequence execution starting unit 14.

Here, the command sequence is a drawing command group which command-sequence execution unit 18 can interpret. The command sequence includes a command associated with a drawing primitive, such as a point, line, and triangle, and a command to set texture information to be referenced, for example.

In second-priority command-sequence storage unit 12, a command sequence (also referred to as a “second-priority command sequence” or “second command,” hereinafter) is set to draw an image in a drawing area which is different from the drawing area having the highest drawing priority, among the plurality of the drawing areas on the screen. The priority of the second-priority command sequence is also referred to as the second drawing priority. That is, second-priority command-sequence storage unit 12 is a register or a storage area which stores the second command to draw the image in a second drawing area, which has a drawing priority lower than the first drawing priority, among the plurality of the drawing areas. First-priority command-sequence storage unit 12 corresponds to a second storage unit.

More specifically, in second-priority command-sequence storage unit 12, a start and end addresses of memory (not shown) which stores the command sequence are set. A case is considered where there exists a plurality of drawing areas different from the highest-priority drawing area, among the plurality of the drawing areas on the screen. Interposing of a command between the command sequences, which are set respectively for the drawing areas, yields a concatenated command sequence, with the interposed command being to execute an address jump between the command sequences. The thus-concatenated command sequence is set, as a second-priority command sequence, in second-priority command-sequence storage unit 12. Second-priority command-sequence storage unit 12 transmits the second-priority command sequence to second-priority command-sequence execution starting unit 15, in response to a request from second-priority command-sequence execution starting unit 15.

State management unit 13 manages execution state of the command sequences executed by command-sequence execution unit 18. Here, the execution state represents whether or not command-sequence execution unit 18 executes either the first-priority command sequence or the second-priority command sequence. In more detail, the execution state represents whether or not the command sequence is being executed and, when being executed, represents which one of the first-priority command sequence and the second-priority command sequence is being executed.

Moreover, state management unit 13 is equipped with a timer counter (not shown) and measures number-of-counts counted by the timer counter. The timer counter starts a count with the number-of-counts of “0 (zero),” increments it by “1” every rising clock, and then returns it to the number-of-counts of “0 (zero)” whenever the number-of-counts reaches fixed period T. That is, the number-of-counts transits between not smaller than “0 (zero)” and not larger than “T−1.” Here, fixed period T is a period in time during which at least the execution of the first-priority command sequence can be started and then completed. For example, the period is equal to a vertical synchronization period for drawing an image in one screen of a display device. In other words, when fixed period T is equal to the vertical synchronization period, this configuration is allowed on the precondition that the execution of the first-priority command sequence is guaranteed to be completed within the vertical synchronization period without fail.

First-priority command-sequence execution starting unit 14 refers to the number-of-counts of the timer counter measured by state management unit 13 and, when it becomes time to start fixed period T (the number-of-counts=0 (zero)), requests a readout of the first-priority command sequence from first-priority command-sequence storage unit 11. Moreover, upon reading the first-priority command sequence from first-priority command-sequence storage unit 11, first-priority command-sequence execution starting unit 14 instructs command-sequence execution unit 18 to start to execute the thus-read first-priority command sequence. As a result, every lapse of fixed period T, the drawing is executed without fail in the drawing area having the highest drawing priority among the plurality of the drawing areas. Here, the execution start trigger, which is given by first-priority command-sequence execution starting unit 14 for the first-priority command sequence, is based not on execution instructions by software. Instead, the trigger is given based on the number-of-counts of fixed period T measured by state management unit 13.

Second-priority command-sequence execution starting unit 15 refers to both the execution state, which state management unit 13 manages, of the command sequence executed by command-sequence execution unit 18 and the number-of-counts, which state management unit 13 measures, of the timer counter. When the execution of the first-priority command sequence executed by command-sequence execution unit 18 is completed within a predetermined period of time (the number-of-counts=Tm) from the starting time (the number-of-counts=0 (zero)) of fixed period T, second-priority command-sequence execution starting unit 15 requests a readout of the second-priority command sequence from second-priority command-sequence storage unit 12. Moreover, upon reading the second-priority command sequence from second-priority command-sequence storage unit 12, second-priority command-sequence execution starting unit 15 instructs command-sequence execution unit 18 to start to execute the thus-read second-priority command sequence. In contrast, when the execution of the first-priority command sequence by command-sequence execution unit 18 is completed at time exceeding the predetermined period of time (the number-of-counts=Tm) from the starting time (the number-of-counts=0 (zero)) of fixed period T, second-priority command-sequence execution starting unit 15 does not request the readout of the second-priority command sequence from second-priority command-sequence storage unit 12. As a result, at the point in time when the drawing in the highest-priority drawing area among the plurality of the drawing areas is completed, if the point is within the predetermined period of time (the number-of-counts=Tm) from the starting time (the number-of-counts=0 (zero)) of fixed period T, the execution of the drawing is started in another drawing area different from the highest-priority drawing area, among the plurality of the drawing areas. Here, the execution start trigger, which is given by second-priority command-sequence execution starting unit 15 for the second-priority command sequences, is based not on interrupt instructions by software. Instead, the trigger is given based on both the execution state, which state management unit 13 manages, of the command sequence executed by command-sequence execution unit 18 and the number-of-counts, which state management unit 13 measures, of fixed period T.

Note that the predetermined period of time described above is also referred to as the threshold time.

Command-sequence suspending unit 16 refers to both the execution state, which state management unit 13 manages, of the command sequence executed by command-sequence execution unit 18 and the number-of-counts, which state management unit 13 measures, of the timer counter. When the point in time of the completion of the second-priority command sequence executed by command-sequence execution unit 18 will exceed the predetermined period of time (the number-of-counts=Tm) from the starting time (the number-of-counts=0 (zero)) of fixed period T, command-sequence suspending unit 16 instructs command-sequence execution unit 18 to suspend the execution of the second-priority command sequence. Such a suspension of execution is sometimes also called break execution. Command-sequence suspending unit 16 corresponds to a command break-execution unit.

When the point in time of the completion of the second-priority command sequence executed by command-sequence execution unit 18 is within the predetermined period of time (the number-of-counts=Tm) from the starting time (the number-of-counts=0 (zero)) of fixed period T, command-sequence suspending unit 16 informs suspended-command-sequence resuming unit 17 of that matter.

Here, the predetermined period of time (the number-of-counts=Tm) is determined such that a saving period can be allocated in period “T−Tm” which is obtained by subtracting number-of-counts Tm from fixed period T. The saving period is time necessary to save information (an at-the-suspension drawing context) into a memory area designated by suspended-command-sequence resuming unit 17, with the information including, such as, information of a color and texture settings which have been used in executing the second-priority command sequence until the time of the suspension of execution of the second-priority command sequence. The suspension trigger, which is given by command-sequence suspending unit 16 for the second-priority command sequence, is based not on execution instructions by software. Instead, the trigger is given based on both the execution state, which state management unit 13 manages, of the command sequence executed by command-sequence execution unit 18 and the number-of-counts, which state management unit 13 measures, of fixed period T.

Upon receiving a notice of the suspension of the execution of the second-priority command sequence from command-sequence suspending unit 16, suspended-command-sequence resuming unit 17 sets a saving-command sequence to save the at-the-suspension drawing context and the like into the designated memory area. More specifically, suspended-command-sequence resuming unit 17 adds a suspension and end addresses of the second-priority command sequence to the at-the-suspension drawing context, and stores these addresses into the designated memory area. The suspension address of the second-priority command sequence indicates the point up to which the second-priority command sequence has been executed; the end address (referred to as the at-the-suspension second-priority command sequence, hereinafter) of the second-priority command sequence indicates the point up to which the command sequence had to be executed.

Suspended-command-sequence resuming unit 17 resumes the at-the-suspension drawing context after the completion of executing of the saving-command sequence, and forms a resumption command sequence to resume the execution of the at-the-suspension second-priority command sequence from the point of the suspension. More specifically, suspended-command-sequence resuming unit 17 sets the at-the-suspension second-priority command sequence in second-priority command-sequence storage unit 12, and also informs the storage unit of the memory area in which the at-the-suspension drawing context has been stored. In the case where the at-the-suspension second-priority command sequence is set in second-priority command-sequence storage unit 12, second-priority command-sequence execution starting unit 15 requests a readout of the at-the-suspension second-priority command sequence from second-priority command-sequence storage unit 12, in accordance with interrupt instructions by software. Moreover, upon reading the at-the-suspension second-priority command sequence from second-priority command-sequence storage unit 12, second-priority command-sequence execution starting unit 15 resumes the at-the-suspension drawing context from the designated memory area, and also instructs command-sequence execution unit 18 to start to execute the at-the-suspension second-priority command sequence.

Upon receiving the instructions to start execution from either first-priority command-sequence execution starting unit 14 or second-priority command-sequence execution starting unit 15, command-sequence execution unit 18 executes the designated command sequence. Moreover, upon receiving the instructions to suspend execution from command-sequence suspending unit 16, command-sequence execution unit 18 suspends the command sequence under execution. Command-sequence execution unit 18 corresponds to a command execution unit.

Note that command controller 1 is a graphics processing unit (GPU), for example. A conventional GPU is equipped with only one storage unit (corresponding to first-priority command-sequence storage unit 11) which accepts commands from a central processing unit (CPU). For this reason, such a GPU cannot accept a plurality of command sequences which have different drawing priorities from each other.

On the other hand, in the case where a complicated drawing is performed within one image, the command sequence becomes so long that the drawing to be executed is difficult to complete within a predetermined period of time allocated for drawing one screen. As a result, this poses a possible problem of frame dropping that some frames are missing from the image which the GPU forms and displays. Moreover, the problem becomes more serious with increasing size of the image to be drawn.

Command controller 1 according to the embodiment accepts the plurality of the command sequences having different drawing priorities from each other through use of a plurality of the storage units, that is, first-priority command-sequence storage unit 11 and second-priority command-sequence storage unit 12. Then, command controller 1 is capable of preventing such frame dropping by executing the command sequences in accordance with the drawing priorities of the respective command sequences and, if necessary, suspending the execution of the command sequence at an appropriate timing.

### 1-2. Operation

Hereinafter, descriptions will be made regarding operations of command controller 1 configured as described above.

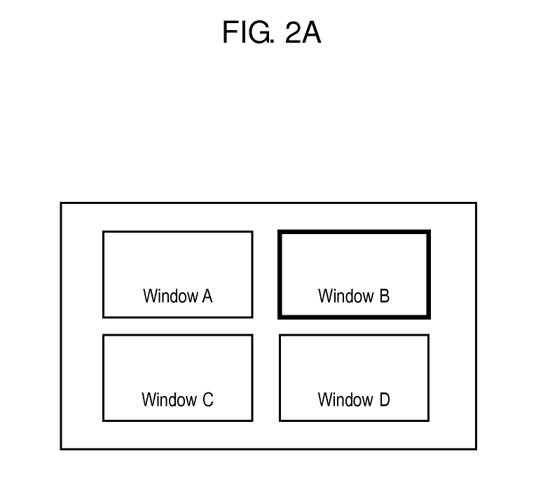

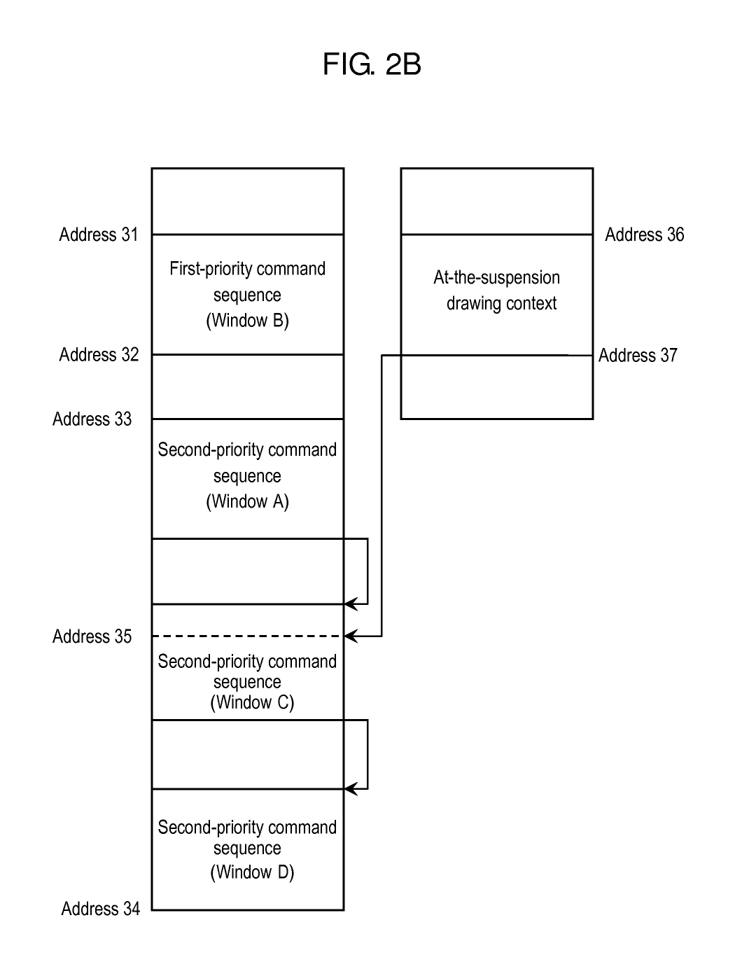

FIGS. 2A and 2B are illustrative views of processes performed by the command controller according to the embodiment. The operations of command controller 1 will be described using a case where four drawing areas (windows A, B, C, and D) are displayed in one screen and window B is selected from them with a cursor or the like, as shown in FIG. 2A.

At this moment, as shown in FIG. 2B, in first-priority command-sequence storage unit 11, a command sequence is set, as the first-priority command sequence, to draw window B which is selected and designated as the highest-priority drawing area among the four drawing areas. First-priority command-sequence storage unit 11 corresponds to the memory area from address 31 to address 32 of FIG. 2B. It is noted that the term of “address” as simply referred herein means “address in a memory area (so-called memory address).”

Moreover, in second-priority command-sequence storage unit 12, a command sequence is set, as the second-priority command sequence, to draw windows A, C, and D which are designated as drawing areas different from the highest-priority drawing area among the four drawing areas. The command sequence to draw windows A, C, and D is configured including address jump commands interposed therein. Second-priority command-sequence storage unit 12 corresponds to the memory area from address 33 to address 34 of FIG. 2B. Moreover, in second-priority command-sequence storage unit 12, the at-the-suspension second-priority command sequence, which is set just at the time of the suspension of execution of the second-priority command sequence, is stored in the memory area from address 35 to address 34. Furthermore, the at-the-suspension drawing context is stored in the memory area from address 36 to address 37.

It is noted, however, the window selected from the four drawing area with a cursor or the like may be dynamically changed through an operation by a user, for example. When such a change is made, the drawing command sequence for a newly-selected window with a cursor or the like, is dynamically changed to be a new first-priority command sequence.

It is noted, however, that the number of the selected windows is not limited to one, and may be two or more.

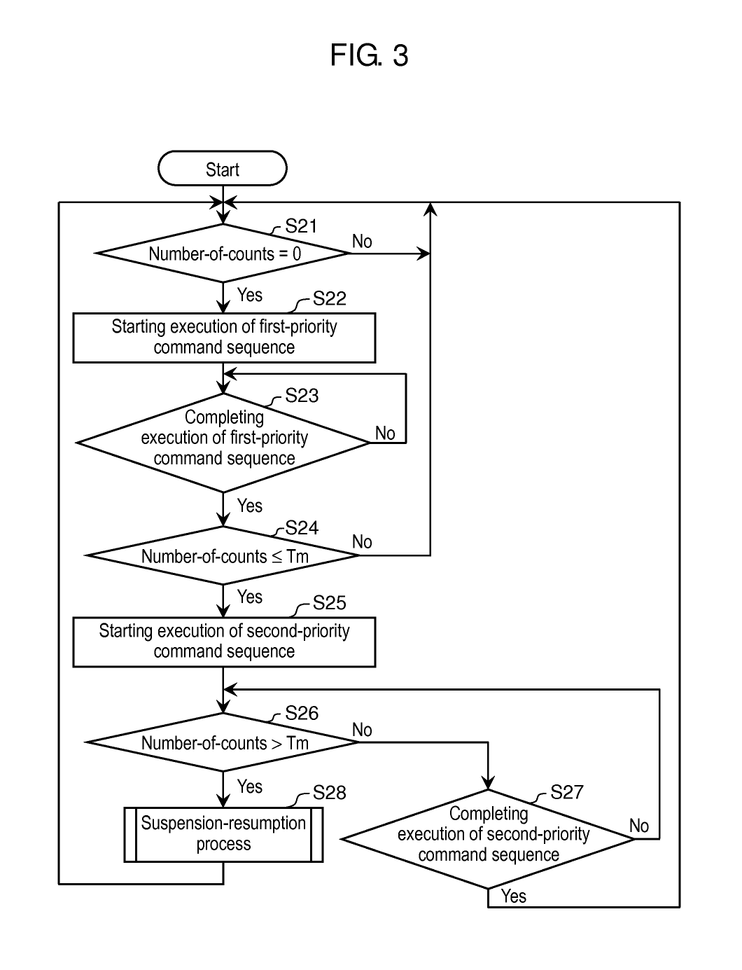

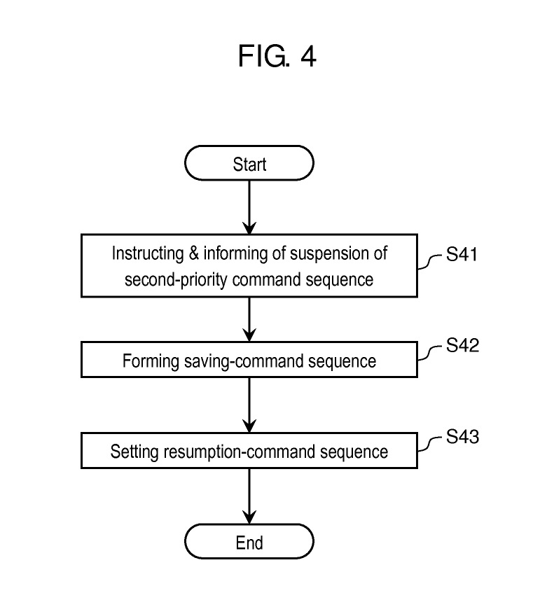

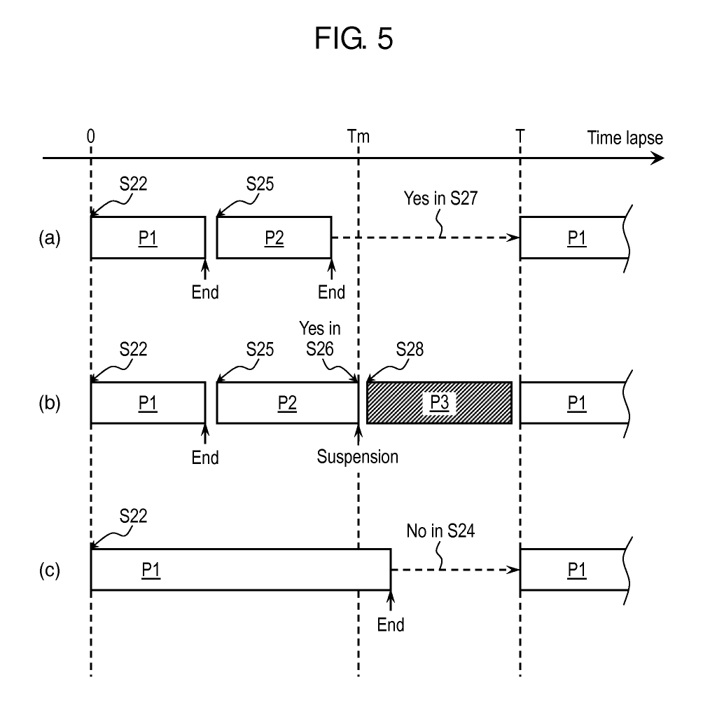

Referring to FIGS. 3 to 5, processing executed by the command controller according to the embodiment will be described. Note that FIGS. 3 and 4 show the processing executed by the command controller, while FIG. 5 shows a flow of a series of the processes with respect to elapsed time. In FIG. 5, process steps of FIGS. 3 and 4 corresponding respectively to the processes are also shown. FIG. 5 shows the executions indicated by symbols as follows: The execution of the first-priority command sequence by command-sequence execution unit 18 is indicated by symbol P1 (a period of the execution of the first-priority command sequence). The execution of the second-priority command sequence by command-sequence execution unit 18 is indicated by symbol P2 (a period of the execution of the second-priority command sequence). The execution of a suspension-resumption process by command-sequence suspending unit 16 is indicated by symbol P3 (a period of the execution of the suspension-resumption process).

FIG. 3 is a flowchart which illustrates the command execution processing of the command controller according to the embodiment.

In Step S21, first-priority command-sequence execution starting unit 14 refers to the number-of-counts of the timer counter which state management unit 13 measures, and determines whether or not the number-of-counts reaches a starting point of fixed period T (the number-of-counts=0 (zero)).

In Step S21, when the number-of-counts of the timer counter is determined to reach the starting point of fixed period T (Yes, in Step S21), the process proceeds to Step S22. When the number-of-counts of the timer counter is determined not yet to reach the starting point of fixed period T (No, in Step S21), Step S21 is executed again. That is, first-priority command-sequence execution starting unit 14 waits at Step S21 until the number-of-counts of the timer counter reaches the starting point of fixed period T.

In Step S22, first-priority command-sequence execution starting unit 14 requests a readout of the first-priority command sequence (more specifically, the sequence from address 31 to address 32 where the first-priority command sequence is stored) from first-priority command-sequence storage unit 11. Upon reading the first-priority command sequence from first-priority command-sequence storage unit 11, first-priority command-sequence execution starting unit 14 instructs command-sequence execution unit 18 to start to execute the thus-read first-priority command sequence. Upon receiving the instructions to start to execute the first-priority command sequence from first-priority command-sequence execution starting unit 14, command-sequence execution unit 18 starts to execute the first-priority command sequence that is stored between address 31 and address 32. Once the execution of the first-priority command sequence has been started, first-priority command-sequence execution starting unit 14 waits until when the execution of the next first-priority command sequence is started at the next starting point of fixed period T (the number-of-counts=0 (zero)).

In Step S23, second-priority command-sequence execution starting unit 15 determines whether or not the execution of the first-priority command sequence is completed. Specifically, second-priority command-sequence execution starting unit 15 refers to both the execution state, which state management unit 13 manages, of the command sequence executed by command-sequence execution unit 18 and the number-of-counts, which state management unit 13 measures, of the timer counter. When second-priority command-sequence execution starting unit 15 determines that the execution of the first-priority command sequence is completed by command-sequence execution unit 18 (Yes, in Step S23), the process proceeds to Step S24. In contrast, when the judgment is that the execution of the first-priority command sequence is not completed yet, Step S23 is executed again.

In Step S24, second-priority command-sequence execution starting unit 15 determines whether or not the number-of-counts of the timer counter is within the predetermined period of time (the number-of-counts=Tm) from the starting point of fixed period T (the number-of-counts=0 (zero)) to. When the number-of-counts of the timer counter is determined to be within the predetermined period of time (Yes, in Step S24), the step proceeds to Step S25. In contrast, when the number-of-counts of the timer counter is determined to be out of the predetermined period of time (i.e., it exceeds the predetermined period of time) (No, in Step S24), the process proceeds to Step S21. Moreover, also when the second-priority command sequence is not set, the process proceeds to Step S21.

Note that it is assumed here that number-of-counts Tm described above is determined in advance such that command-sequence execution unit 18 can complete the execution of the first-priority command sequence by the time when the number-of-counts counts up to the Tm.

When the process proceeds from Step S24 to Step S21 as described above, second-priority command-sequence execution starting unit 15 does not start to execute the second-priority command sequence and waits until when the execution of the next first-priority command sequence is completed in next fixed period T.

In Step S25, second-priority command-sequence execution starting unit 15 requests a readout of the second-priority command sequence (more specifically, the sequence from address 33 to address 34 where the second-priority command sequence is stored) from second-priority command-sequence storage unit 12. However, when the at-the-suspension second-priority command sequence is set in second-priority command-sequence storage unit 12, second-priority command-sequence execution starting unit 15 requests a readout of the at-the-suspension second-priority command sequence (more specifically, the sequence from address 35 to address 34 where the at-the-suspension second-priority command sequence is stored) from second-priority command-sequence storage unit 12. Moreover, upon reading the at-the-suspension second-priority command sequence from second-priority command-sequence storage unit 12, second-priority command-sequence execution starting unit 15 resumes the at-the-suspension drawing context from the designated memory area (more specifically, the area from address 36 to address 37 where the at-the-suspension drawing context is stored), and also instructs command-sequence execution unit 18 to start to execute the at-the-suspension second-priority command sequence.

Upon reading the second-priority command sequence from second-priority command-sequence storage unit 12, second-priority command-sequence execution starting unit 15 instructs command-sequence execution unit 18 to start to execute the thus-read second-priority command sequence. Upon receiving the instructions to start to execute the second-priority command sequence from second-priority command-sequence execution starting unit 15, command-sequence execution unit 18 starts to execute the second-priority command sequence that is stored between address 33 and address 34. Moreover, when the at-the-suspension second-priority command sequence is set in second-priority command-sequence storage unit 12, second-priority command-sequence execution starting unit 15 requests, in accordance with interrupt instructions by software, a readout of the at-the-suspension second-priority command sequence (more specifically, the sequence from address 35 to address 34 where the at-the-suspension second-priority command sequence is stored) from second-priority command-sequence storage unit 12. Furthermore, upon reading the at-the-suspension second-priority command sequence from second-priority command-sequence storage unit 12, second-priority command-sequence execution starting unit 15 resumes the at-the-suspension drawing context from the designated memory area (more specifically, the area from address 36 to address 37 where the at-the-suspension drawing context is stored), and also instructs command-sequence execution unit 18 to start to execute the at-the-suspension second-priority command sequence.

Once the execution of the second-priority command sequence has been started, second-priority command-sequence execution starting unit 15 waits until when the execution of the next first-priority command sequence is completed in next fixed period T.

In Step S26, command-sequence suspending unit 16 refers to both the execution state, which state management unit 13 manages, of the command sequence executed by command-sequence execution unit 18 and the number-of-counts, which state management unit 13 measures, of the timer counter. Then, the command-sequence suspending unit determines whether or not the predetermined period of time (the number-of-counts=Tm) has elapsed from the starting time (the number-of-counts=0 (zero)) of fixed period T.

In Step S26, when the predetermined period of time (the number-of-counts=Tm) is determined not to have elapsed from the starting time (the number-of-counts=0 (zero)) of fixed period T (No, in Step S26), the process proceeds to Step S27. In contrast, when the predetermined period of time (the number-of-counts=Tm) is determined to have elapsed from the starting time (the number-of-counts=0 (zero)) of fixed period T (Yes, in Step S26), the process proceeds to Step S28.

In Step S27, command-sequence execution unit 18 continues to execute the second-priority command sequence, without instructing command-sequence execution unit 18 to suspend the execution of the second-priority command sequence. Moreover, command-sequence execution unit 18 determines whether or not the execution of the second-priority command sequence is completed. When the execution of the second-priority command sequence is determined to be completed (Yes, in Step S27), the process proceeds to Step S21. In contrast, when the execution of the second-priority command sequence is determined not to be completed (No, in Step S27), the process proceeds to Step S26.

In Step S28, command-sequence suspending unit 16 executes the suspension-resumption process. Details of the suspension-resumption process will be described later.

Through the series of processes from Step S21 to Step S28, command-sequence execution unit 18 can execute the first-priority command sequence from the starting time of every fixed period T.

Note that the flow of the processes indicated by (a) of FIG. 5 shows the case where execution P1 of the first-priority command sequence is started (Step S22), execution P1 of the first-priority command sequence is completed (Yes, in Step S23), execution P2 of the second-priority command sequence is started (Step S25), and then execution P2 of the second-priority command sequence is completed within the predetermined period of time (Yes, in Step S27).

Note that the flow of the processes indicated by (b) of FIG. 5 shows the case where execution P1 of the first-priority command sequence is started (Step S22), execution P1 of the first-priority command sequence is completed (Yes, in Step S23), execution P2 of the second-priority command sequence is started (Step S25), and then execution P3 of the suspension-resumption process is executed because the predetermined period of time has elapsed during the execution of the second-priority command sequence (No, in Step S27).

Note that the flow of the processes indicated by (c) of FIG. 5 shows the case where, execution P1 of the first-priority command sequence is started (Step S22), and then execution P1 of the first-priority command sequence is completed (Yes, in Step S23) after the lapse of the predetermined period of time (No, in Step S24).

In this way, in any of the cases (a) to (c) of FIG. 5, execution P1 of the first-priority command sequence is started at time 0 (zero) and time T. Moreover, when time is available for execution P2 of the second-priority command sequence within fixed period T, execution P2 of the second-priority command sequence is executed. Furthermore, when it is expected during execution P2 of the second-priority command sequence that execution P2 will not be completed by the end of fixed period T, execution P2 is suspended so as not to prevent execution P1 of the first-priority command sequence from being started at time T. In this way, command controller 1 allows an increase in quality of images to be drawn.

FIG. 4 is a flowchart which illustrates a suspension-resumption process executed by the command controller according to the embodiment.

In Step S41, command-sequence suspending unit 16 refers to both the execution state, which state management unit 13 manages, of the command sequence executed by command-sequence execution unit 18 and the number-of-counts, which state management unit 13 measures, of the timer counter. When the completion of execution of the second-priority command sequence by command-sequence execution unit 18 exceeds the predetermined period of time (the number-of-counts=Tm) from the starting time (the number-of-counts=0 (zero)) of fixed period T, command-sequence suspending unit 16 instructs command-sequence execution unit 18 to suspend (or break) the execution of the second-priority command sequence. In addition, when the completion of execution of the second-priority command sequence by command-sequence execution unit 18 exceeds the predetermined period of time (the number-of-counts=Tm) from the starting time (the number-of-counts=0 (zero)) of fixed period T, command-sequence suspending unit 16 informs suspended-command-sequence resuming unit 17 of that matter.

In Step S42, upon receiving the notice of the suspension of execution of the second-priority command sequence from command-sequence suspending unit 16, suspended-command-sequence resuming unit 17 sets a saving-command sequence to save the at-the-suspension drawing context and the like into the designated memory area. More specifically, suspended-command-sequence resuming unit 17 adds the at-the-suspension second-priority command sequence to the at-the-suspension drawing context, and stores it as an at-the-suspension drawing context into the designated memory area from address 36 to address 37.

In Step S43, suspended-command-sequence resuming unit 17 resumes the at-the-suspension drawing context after the completion of executing of the saving-command sequence, and forms a resumption command sequence to resume the execution of the at-the-suspension second-priority command sequence from the point of the suspension. More specifically, suspended-command-sequence resuming unit 17 sets the at-the-suspension second-priority command sequence (more specifically, the sequence from address 35 to address 34 where at-the-suspension second-priority command sequence is stored) in second-priority command-sequence storage unit 12, and also informs the second-priority command-sequence storage unit of address 36 to address 37 where the at-the-suspension drawing context is stored.

Note that second-priority command-sequence execution starting unit 15 resumes the execution of the second-priority command sequence, which has been suspended as described above, at a predetermined timing. The predetermined timing is a point in time when the interrupt instructions are made by software, for example.

Specifically, in the case where the at-the-suspension second-priority command sequence is set in second-priority command-sequence storage unit 12, second-priority command-sequence execution starting unit 15 requests a readout of the at-the-suspension second-priority command sequence (more specifically, the sequence from address 35 to address 34 where the at-the-suspension second-priority command sequence is stored) from second-priority command-sequence storage unit 12, in accordance with interrupt instructions by software. Then, upon reading the at-the-suspension second-priority command sequence from second-priority command-sequence storage unit 12, second-priority command-sequence execution starting unit 15 resumes the at-the-suspension drawing context from the designated memory area, and also instructs command-sequence execution unit 18 to start to execute the at-the-suspension second-priority command sequence. Note that the resumption of execution of the second-priority command sequence is performed after the execution of the first-priority command sequence in the frame next, in chronological order, to the frame where the execution of the second-priority command sequence has been suspended.

### 1-3. Modified Examples of Configuration

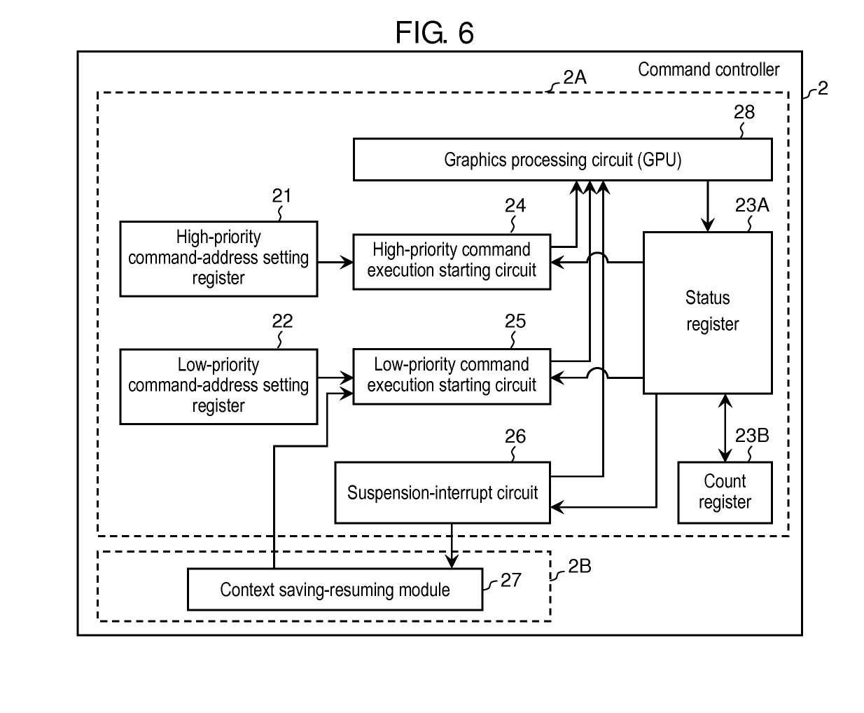

FIG. 6 is a block diagram of another configuration (command controller 2) of the command controller according to the embodiment.

As shown in FIG. 6, command controller 2 includes function blocks 2A and 2B.

Function block 2A includes high-priority command-address setting register 21, low-priority command-address setting register 22, status register 23A, count register 23B, high-priority command execution starting circuit 24, low-priority command execution starting circuit 25, suspension-interrupt circuit 26, and graphics processing circuit 28. Note that function block 2A is expected to be implemented by hardware.

High-priority command-address setting register 21 corresponds to first-priority command-sequence storage unit 11.

Low-priority command-address setting register 22 corresponds to second-priority command-sequence storage unit 12.

Status register 23A and count register 23B correspond to state management unit 13.

High-priority command execution starting circuit 24 corresponds to first-priority command-sequence execution starting unit 14.

Low-priority command execution starting circuit 25 corresponds to second-priority command-sequence execution starting unit 15.

Suspension-interrupt circuit 26 corresponds to command-sequence suspending unit 16.

Graphics processing circuit 28 corresponds to command-sequence execution unit 18.

Function block 2B includes context saving-resuming module 27. Note that function block 2B is expected to be implemented by software, more specifically by driver software.

Context saving-resuming module 27 corresponds to suspended-command-sequence resuming unit 17.

With such command controller 2, the same advantages of command controller 1 described above are achieved.

### 1-4. Advantages and Others

As described above, command controller 1 according to the embodiment is intended to execute commands to draw images in a plurality of drawing areas on a screen. Command controller 1 includes first-priority command-sequence storage unit 11, second-priority command-sequence storage unit 12, and command-sequence execution unit 18. First-priority command-sequence storage unit 11 stores the first command to draw an image in the first drawing area having the first drawing priority, among the plurality of the drawing areas. Second-priority command-sequence storage unit 12 stores the second command to draw an image in the second drawing area having the second drawing priority lower than the first drawing priority, among the plurality of the drawing areas. Command-sequence execution unit 18 executes, every predetermined period, the first command stored in first-priority command-sequence storage unit 11 to draw the image in the first drawing area. Moreover, command-sequence execution unit 18 determines whether or not the execution of the first command is completed at time within the threshold time shorter than the predetermined period from the starting point of the predetermined period. When the execution of the first command is determined to be completed at time within the threshold time, the command-sequence execution unit executes the second command stored in second-priority command-sequence storage unit 12 to draw the image in the second drawing area.

With this configuration, command controller 1 executes the first command every predetermined period. Moreover, the command controller executes the second command when an enough time period is available to execute the second command after the execution of the first command. This configuration allows the first command to be executed every predetermined period, resulting in an improved quality of the drawing in the second drawing area as well as a highly-maintained quality of the drawing in the first drawing area. Therefore, command controller 1 is capable of improving the quality of images displayed.

Moreover, even when the drawing priorities of the respective drawing areas are dynamically changed among the plurality of the drawing areas, command controller 1 is capable of improving the quality of the image in the highest-priority drawing area.

Furthermore, command controller 1 may determine whether or not command-sequence execution unit 18 is executing the second command at the point in time of a lapse of the threshold time from the starting point of the predetermined period. Then, command controller 1 may include command-sequence suspending unit 16 to suspend the execution of the second command when command-sequence execution unit 18 is determined to be executing the second command.

With this configuration, when there is a possibility during the execution of the second command that the second command under execution cannot be completed within the current period, command controller 1 suspends the execution of the second command. This allows command controller 1 to start, without fail, the first command at the starting point of the predetermined period, resulting in the increase in display quality of the image in the highest-priority drawing area even when the drawing priorities of the respective drawing areas are dynamically changed among the plurality of the drawing areas.

Furthermore, when the execution of the second command has been suspended, command controller 1 may include suspended-command-sequence resuming unit 17 that instructs command-sequence execution unit 18 to resume the execution of the second command at a predetermined timing after the suspension.

With this configuration, even when an in-progress process of drawing an image has been suspended, command controller 1 is allowed to resume the suspended process, thereby completing the image in progress of drawing. Therefore, the command controller is capable of increasing the quality of the image to be drawn.

Moreover, command-sequence execution unit 18 may determine whether or not the point in time of the completion of execution of the first command is after the lapse of the threshold time from the starting point of the predetermined period. Then, when the point is determined to be after the lapse of the threshold time, command-sequence execution unit 18 may prohibit the execution of the second command.

With this configuration, when time is not available for execution of the second command after the execution of the first command, command controller 1 does not execute the second command and waits until the execution of the first command in the next predetermined period. As a result, command controller 1 can more reliably execute the first command in the next predetermined period.

Moreover, the predetermined period may be equal to a vertical synchronization interval of the display device which displays the image drawn by command controller 1.

With this configuration, the command controller executes the first command every vertical synchronization interval of the display device. This allows the command controller to increase the quality of the image to be displayed.

Moreover, a method for controlling commands according to the embodiment is intended for use in command controller 1 that executes commands to draw images in a plurality of drawing areas on a screen. Command controller 1 includes first-priority command-sequence storage unit 11 and second-priority command-sequence storage unit 12. First-priority command-sequence storage unit 11 stores the first command to draw an image in the first drawing area having the first drawing priority, among the plurality of the drawing areas. Second-priority command-sequence storage unit 12 stores the second command to draw an image in the second drawing area having the second drawing priority lower than the first drawing priority, among the plurality of the drawing areas. The method for controlling commands includes a first-command execution step and a second-command execution step. The first-command execution step includes executing the first command stored in first-priority command-sequence storage unit 11, every predetermined period, to draw the image in the first drawing area. The second-command execution step includes: judging whether or not the execution of the first command is completed at time within the threshold time shorter in time than the predetermined period from the starting point of the predetermined period; and executing the second command stored in second-priority command-sequence storage unit 12 when the execution of the first command is determined to be completed at the time within the threshold time, thereby drawing the image in the second drawing area.

This configuration allows the same advantages of the command controller described above.

Moreover, an integrated circuit according to the embodiment is intended to execute commands to draw images in a plurality of drawing areas on a screen. The integrated circuit includes first-priority command-sequence storage unit 11, second-priority command-sequence storage unit 12, and command-sequence execution unit 18. First-priority command-sequence storage unit 11 stores the first command to draw an image in the first drawing area having the first drawing priority, among the plurality of the drawing areas. Second-priority command-sequence storage unit 12 stores the second command to draw an image in the second drawing area having the second drawing priority lower than the first drawing priority, among the plurality of the drawing areas. Command-sequence execution unit 18 executes, every predetermined period, the first command stored in first-priority command-sequence storage unit 11 to draw the image in the first drawing area. Moreover, command-sequence execution unit 18 determines whether or not the execution of the first command is completed at time within the threshold time shorter than the predetermined period from the starting point of the predetermined period. When the execution of the first command is determined to be completed at the time within the threshold time, the command-sequence execution unit executes the second command stored in second-priority command-sequence storage unit 12 to draw the image in the second drawing area.

This configuration allows the same advantages of the command controller described above.

As described above, the embodiment has been described to exemplify the technology according to the present disclosure. To this end, the accompanying drawings and the detailed descriptions are provided herein.

Therefore, the constituent elements described in the accompanying drawings and the detailed descriptions may include not only essential elements for solving the problems, but also inessential ones for solving the problems which are described only for the exemplification of the implementations described above. For this reason, it should not be acknowledged that these inessential elements are considered to be essential only on the grounds that these inessential elements are described in the accompanying drawings and/or the detailed descriptions.

Moreover, because the aforementioned embodiment is used only for the exemplification of the technology disclosed herein, it is to be understood that various changes and modifications, replacements, additions, omissions, and the like may be made to the embodiment without departing from the scope of the appended claims or the scope of their equivalents.

The technology according to the present disclosure is useful for command sequence control technologies for controlling the execution of a command sequence to draw an image in each of the plurality of the drawing areas on a screen.

What is claimed is:

1. A command controller for executing a command to draw an image in a plurality of drawing areas on a screen, the command controller comprising:
a first storage unit for storing a first command to draw the image in a first drawing area having a first drawing priority among the plurality of the drawing areas;
a second storage unit for storing a second command to draw the image in a second drawing area having a second drawing priority lower than the first drawing priority among the plurality of the drawing areas; and
a command execution unit for executing the first command stored in the first storage unit, every predetermined period, to draw the image in the first drawing area,
wherein the command execution unit determines whether or not the first command is completely executed within a threshold time shorter than the predetermined period from a starting point of the predetermined period, and executes the second command stored in the second storage unit to draw the image in the second drawing area when the first command is determined to be completely executed within the threshold time.

2. The command controller according to claim 1, further comprising a command break-execution unit for determining whether or not the command execution unit is executing the second command after a lapse of the threshold time from the starting point of the predetermined period, and for suspending the execution of the second command when the command execution unit is determined to be executing the second command.

3. The command controller according to claim 2, further comprising a suspended-command-sequence resuming unit for instructing, when the execution of the second command is suspended, the command execution unit to resume the execution of the second command at a predetermined timing after the execution is suspended.

4. The command controller according to claim 1, wherein the command execution unit determines whether or not a point in time of completion of executing the first command is after a lapse of the threshold time from the starting point of the predetermined period, and prohibits the execution of the second command when the point in time of the completion is determined to be after the lapse of the threshold time.

5. The command controller according to claim 1, wherein the predetermined period equals a vertical synchronization interval of a display device that displays the image drawn by the command controller.

6. A method for controlling a command in a command controller for executing the command to draw an image in a plurality of drawing areas on a screen, the command controller including: a first storage unit for storing a first command to draw the image in a first drawing area having a first drawing priority among the plurality of the drawing areas; and a second storage unit for storing a second command to draw the image in a second drawing area having a second drawing priority lower than the first drawing priority among the plurality of the drawing areas,
the method comprising:
a first command execution step of executing the first command stored in the first storage unit, every predetermined period, to draw the image in the first drawing area; and
a second command execution step including:
determining whether or not the first command is completely executed within a threshold time shorter than the predetermined period from a starting point of the predetermined period; and
executing the second command stored in the second storage unit to draw the image in the second drawing area when the first command is determined to be completely executed within the threshold time.

7. An integrated circuit for executing a command to draw an image in a plurality of drawing areas on a screen, the integrated circuit comprising:
a first storage unit for storing a first command to draw the image in a first drawing area having a first drawing priority among the plurality of the drawing areas;
a second storage unit for storing a second command to draw the image in a second drawing area having a second drawing priority lower than the first drawing priority among the plurality of the drawing areas; and
a command execution unit for executing the first command stored in the first storage unit, every predetermined period, to draw the image in the first drawing area,
wherein the command execution unit determines whether or not the first command is completely executed within a threshold time shorter than the predetermined period from a starting point of the predetermined period, and executes the second command stored in the second storage unit to draw the image in the second drawing area when the first command is determined to be completely executed within the threshold time.
